(19) United States
(12) Patent Application Publication
(10) Pub. No.: US 2011/0114259 A1
(43) Pub. Date: May 19, 2011

(54) HYBRID-FUNCTIONAL POLYMERS

(75) Inventor: Andreas Kramer, Zürich (CH)

(73) Assignee: SIKA TECHNOLOGY AG, Baar (CH)

(21) Appl. No.: 13/003,015

(22) PCT Filed: Apr. 30, 2009
(86) PCT No.: PCT/EP2009/055255

§ 371 Date: Jan. 7, 2011

(30) Foreign Application Priority Data
Jul. 9, 2008 (EP) 08159981.3

(51) Int. Cl. C09J 175/04; C08G 18/77; C08F 283/10; C08L 75/04

(52) U.S. Cl. 156/331.7; 528/73; 525/453; 525/454; 524/590

(57) ABSTRACT

Hybrid-functional polymers of formula (I) or formula (II), a method for their preparation and their use. The hybrid-functional polymers may have multiple functional groups. The hybrid-functional polymers may be polyisocyanate compounds with at least one other functional group and polyurethane compositions. The hybrid-functional polymers may be in compositions as well as composites fabricated using the compositions.

### TECHNICAL FIELD

The subject matter of the invention is hybrid-functional polymers, a method for their preparation and their use. The invention also relates to compositions containing the polymers as well as composites fabricated using the composition.

### STATE OF THE ART

The invention relates to the field of hybrid-functional polymers. This means polymers that contain at least two different functional groups. Such polymers are important for many applications. In principle, polymers with more than one functional group can enter into two or more different reactions, facilitating preparation of complex products. So it is fundamentally important to provide versatile hybrid-functional polymers and methods for their preparation.

Hybrid-functional polymers are used, for example, in adhesives, as primers for improving adhesion to surfaces, as sealants, or as activators. For use as an adhesive or primer layer, for example, one functional group is selected so that it reacts with a surface, while a second functional group reacts with a substrate. In this way, substrates can be fixed to surfaces.

Hybrid-functional polymers that have at least two isocyanate radicals are of special importance. Such hybrid-functional polymers can be used in polyurethane chemistry, where the functional groups that are not isocyanate radicals allow for further processing or give the polyurethane special properties.

Polyurethanes (PU, DIN abbreviation: PUR) are plastics or synthetic resins which are formed from the polyaddition reaction of diols, or polyols, with polyisocyanates.

Polyurethanes can have different properties, depending on the choice of the isocyanate and the polyol. The later properties are essentially determined by the polyol component, since often in order to achieve the desired properties, the polyol component is adjusted (i.e., chemically altered) rather than the isocyanate component.

Many products are made from polyurethanes, such as, for example, seals, tubing, flooring, lacquers, and also in particular adhesives.

Additionally, special copolymers have been used for a long time in the prior art which are called “liquid rubbers”. Such liquid rubbers are incorporated into the matrix by use of chemically reactive groups such as epoxy, carboxyl, vinyl, or amino groups. Thus, for example, reactive liquid rubbers derived from butadiene/acrylonitrile copolymers have existed for a long time which are terminated by epoxy, carboxyl, vinyl, or amino groups and that are sold under the trade names Hypro™ (formerly Hycar®) by Nanoresins AG, Germany or Emerald Performance Materials LLC.

For this purpose, carboxyl group-terminated butadiene/acrylonitrile copolymer (CTBN) is always used as the starting material, to which usually a considerable excess of diamine, diepoxide, or glycidyl(methyl)acrylate is added. But this results in a high viscosity on the one hand, or on the other hand a very high content of unreacted diamine, diepoxide, or glycidyl(meth)acrylate, which either must be removed at high cost or else the mechanical properties are very negatively affected.

The use of such butadiene/acrylonitrile polymers having epoxy, carboxyl, amine, or vinyl functional groups in adhesives is already known in the prior art.

Hydroxyl-functional variants thereof, which are of more interest for polyurethane chemistry than the amino-functional products and polyols for reacting with the isocyanate component, are technically demanding and expensive to prepare, and are mostly obtained by reaction of CTBN with ethylene oxide. Primary alcohol end groups are thus obtained. The polyethylene glycol groups formed in this way are in addition disadvantageously in contact with water.

For example, U.S. Pat. No. 4,444,692 discloses preparation of hydroxyl-terminated reactive liquid polymers by reaction of ethylene oxide, in the presence of an amine catalyst, with a carboxyl-terminated reactive liquid polymer. As mentioned above, this results in primary alcohol end groups in the polymer.

U.S. Pat. No. 3,712,916 also describes hydroxyl-terminated polymers that are useful as adhesives and sealant materials. These hydroxyl-terminated polymers are also prepared by reaction of carboxyl-terminated polymers with ethylene oxides in the presence of a tertiary amino catalyst.

Other ways to prepare hydroxyl-functional variants are reaction of terminal carboxylic acids with amino alcohols or with low molecular weight diols. In both cases, large excesses must be worked with, which results in costly workup.

U.S. Pat. No. 4,489,008 discloses hydrolytically stable hydroxyl-terminated liquid polymers that are useful in preparation of polyurethanes. These are prepared by reaction of at least one amino alcohol with a carboxyl-terminated polymer. The reaction of a carboxyl-terminated polymer with at least one compound having at least one epoxy group is not disclosed. The improved hydrolytic stability of the end product compared with conventional polyurethane is emphasized.

U.S. Pat. No. 3,551,472 describes hydroxyl-terminated polymers that are prepared by reaction of carboxyl-terminated polymers with a C₃-C₆ alkylene diol in the presence of an acid catalyst.

It is indicated that these are useful as adhesives and sealant materials.

U.S. Pat. No. 3,699,153 likewise describes hydroxyl-terminated polymers that are prepared by reaction of carboxyl-terminated polymers with a C₃-C₆ alkylene diol.

EP-A-1 916 272 describes heat-curing epoxy resin compositions which include at least one epoxy resin, at least one specifically end-blocked polyurethane polymer, as well as one specifically epoxy group-terminated polyurethane polymer.

### DESCRIPTION OF THE INVENTION

The aim of the present invention is provide hybrid-functional polymers that overcome the indicated problems. Hybrid-functional polymers and a method for their preparation shall be provided. The polymers shall be able to be prepared by comparatively simple methods. The preparation method shall make it possible to variably give polymers as many different functional groups as possible.

The aim of the present invention is also to provide improved compositions, in particular adhesives, sealants, and primers, that have improved adhesion to very different substrates. Another aim of the present invention is to provide tougheners with terminal functional groups that can overcome the indicated problems in the prior art and in particular can avoid the technically demanding and expensive reaction of the carboxyl group-terminated polymers with ethylene oxide.

A particular aim of the invention is to provide polyisocyanate compounds with at least one other functional group, as well as polyurethane compositions for the indicated applications.

The prefix “poly” used in the present invention in substance names such as “polyisocyanate” generally indicates that the respective substance formally contains more than one of the functional group appearing in its name per molecule.

In this document, “phenol groups” mean hydroxyl groups which are directly bonded to an aromatic ring, regardless of whether one or more such hydroxyl groups are bonded directly to the ring.

The problem addressed by the invention is surprisingly solved by hybrid-functional polymers, compositions, composites, methods for their preparation and their use as specified in Claims 1 to 20.

An essential aim of this invention is to provide hybrid-functional polymers, i.e., polymers which have two different chemically reactive functional groups.

A subject matter of the invention is a hybrid-functional polymer of formula (I):

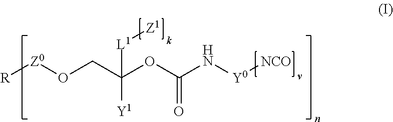

where R stands for an n-valent polymer radical;
Z⁰ stands for —CO— or —X—CO—R²—CO— or —X—CO—[X¹]ₘA-;
X stands for O, NR⁴, or S, where R⁴ in turn stands for H or an alkyl group with 1 to 10 carbon atoms;
X¹ stands for NR⁴, CH₂, or C₂H₄ and m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group;
A stands for an optionally substituted arylene radical;
Y⁰ stands for a (v+1)-valent polyisocyanate radical after removal of the isocyanate groups.
Y¹ stands for H or for a methyl group;
Z¹ stands for a functional group which is different from NCO and which is not reactive with isocyanate groups;
L¹ stands for a (k+1)-valent organic radical which links the functional group Z¹ to the rest of the molecule of formula (I);
k stands for 1 or 2 or 3;
v stands for 1 or 2 or 3, and
   n stands for 2 or 3 or 4.

A subject matter of the invention is also a hybrid-functional polymer of formula (II):

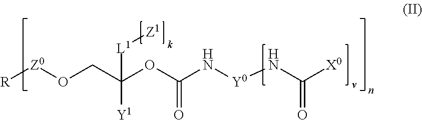

where R stands for an n-valent polymer radical;
Z⁰ stands for —CO— or —X—CO—R²—CO— or —X—CO—[X¹]ₘA-;
X stands for O, NR⁴, or S, where R⁴ in turn stands for H or an alkyl group with 1 to 10 carbon atoms;
X¹ stands for NR⁴, CH₂, or C₂H₄ and m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group;
A stands for an optionally substituted arylene radical;

Y⁰ stands for a (v+1)-valent polyisocyanate radical after removal of the isocyanate groups.
Y¹ stands for H or for a methyl group;

Z¹ stands for a functional group which is different from NCO and which is not reactive with isocyanate groups;

L¹ stands for a (k÷1)-valent organic radical which links the functional group Z¹ to the rest of the molecule of formula (II);

X⁰ stands for a blocking group different from Z¹ which is cleaved at a temperature above 100° C., or for a radical of formula (II′)

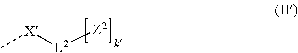

where Z² stands for a functional group which is different from Z¹ and from NCO and which is not reactive with isocyanate groups or is less reactive with isocyanate groups than the group HX′;
L² stands for a (k′+1)-valent organic radical which links the functional group Z² to the rest of the molecule of formula (II);
X′ stands for O, NH, NR³, or S,
   where R³ stands for an alkyl radical that is branched or unbranched and/or saturated or unsaturated, or stands for an aryl or alkaryl radical that is optionally substituted, or stands for a radical of formula -L²-[Z²]_{k′};
   k′ stands for 1 or 2 or 3;

k stands for 1 or 2 or 3;

v stands for 1 or 2 or 3, and

n stands for 2 or 3 or 4.

In further preferred embodiments of the invention, Z⁰ stands for —CO— and R stands for a carboxyl group-terminated butadiene/acrylonitrile copolymer (CTBN) after removal of the terminal carboxyl groups.

In further preferred embodiments of the invention, Z⁰ stands for —X—CO—R²—CO— and R stands for an n-valent radical of a polymer R¹—[XH]ₙ after removal of n XH groups.

In further preferred embodiments of the invention, R¹ stands for a poly(oxyalkylene) polyol, polyester polyol, poly(oxyalkylene) polyamine, polyalkylene polyol, polycarbonate polyol, polymercaptan, polyhydroxy polyurethane or hydroxyl-terminated polysiloxane after removal of the hydroxyl, amine, or mercaptan groups.

In further preferred embodiments of the invention, Z⁰ stands for —X—CO—[X¹]ₘA- and A stands for a phenylene group.

In a further preferred embodiment of the invention, Z¹ is selected from the group consisting of (meth)acrylate, silane, vinyl, allyl, nitrite, and epoxy.

In this document, “silane” means compounds in which first of all at least one, usually 2 or 3 alkoxy groups or acyloxy groups are bonded directly to the silicon atom (through an Si—O bond) and that secondly have at least one organic radical directly bonded to the silicon atom (through an Si—C bond) and have no Si—O—Si bonds. Accordingly, the term “silane group” means the silicon-containing group bonded to the organic radical of the organoalkoxysilane or organoacyloxysilane.

In a further preferred embodiment of the invention, L¹ stands for a methylene group.

In a further preferred embodiment of the invention, Y⁰ stands for a polycyanate after removal of the isocyanate groups, where the polyisocyanate is selected from the group consisting of 1,6-hexamethylene diisocyanate (HDI), 1-isocyanato-3,3,5-trimethyl-5-isocyanatomethylcyclohexane (=isophorone diisocyanate or IPDI), 2,4- and 2,6-toluoylene diisocyanate and any mixtures of these isomers (TDI), 4,4′-, 2,4′-, and 2,2′-diphenylmethane diisocyanate and any mixtures of these isomers (MDI), biurets of the aforementioned polyisocyanates, uretdiones of the aforementioned polyisocyanates and isocyanurates of the aforementioned polyisocyanates.

In a further preferred embodiment of the invention, Z² is selected from the group consisting of isocyanate, epoxy, glycidyl, amine, (meth)acrylate, Mane, vinyl, allyl, and nitrile.

X⁰ is firstly a blocking group which is cleaved at a temperature above 100° C. The blocking group can be obtained by reaction with the isocyanate group of a hybrid-functional polymer of formula (I). On cleavage, we once again have an isocyanate group. Thus the group

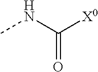

can be called a blocked isocyanate group.

In a further preferred embodiment of the invention, X⁰ is a radical selected from the group consisting of

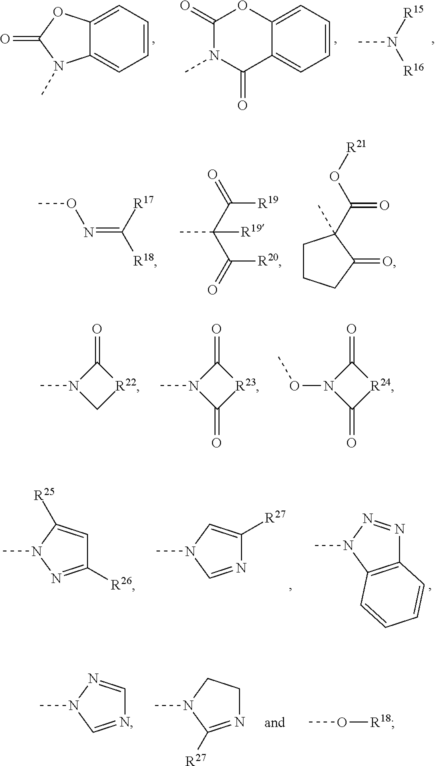

where

R¹⁵, R¹⁶, R¹⁷, and R¹⁸ each independently stands for an alkyl or cycloalkyl or aryl or aralkyl or arylalkyl group

or else R¹⁵ together with R¹⁶, or R¹⁷ together with R¹⁸ form part of a 4- to 7-membered ring, which is optionally substituted;

R¹⁹, R^{19′}, and R²⁰ each independently stands for an alkyl or aralkyl or aryl or arylalkyl group or for an alkyloxy or aryloxy or aralkyloxy group;

R²¹ stands for an alkyl group,

R²², R²³, and R²⁴ each independently stand for an alkylene group with 2 to 5 C atoms, which optionally has double bonds or is substituted, or for a phenylene group or for a hydrogenated phenylene group;

R²⁵, R²⁶, and R²⁷ each independently stand for H or for an alkyl group or for an aryl group or an aralkyl group; and

R²⁸ stands for an aralkyl group or for a mononuclear or polynuclear substituted or unsubstituted aromatic group, which optionally has aromatic hydroxyl groups. Especially suitable as R²⁸ is 3-pentadecenylphenyl, or cardanol (from cashew nutshell oil), after removal of the phenol OH group.

A subject matter of the invention is also a method for preparation of a hybrid-functional polymer of formula (I) as specified in the preceding claims, including the steps:
a) Preparation of a carboxyl group-terminated polymer of formula (IIIa) or (IIIb) or a phenol group-terminated polymer of formula (IV), in particular of formula (IVa), and an epoxy compound of formula (V):

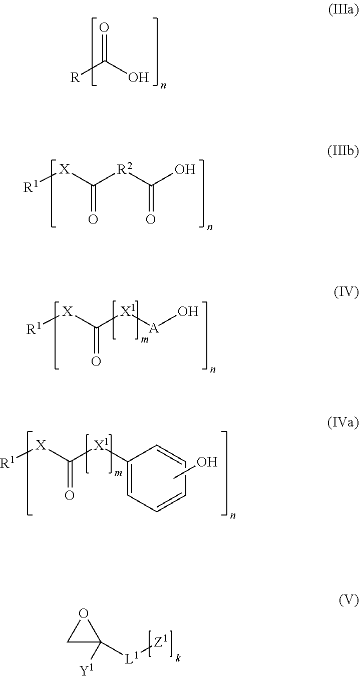

b) Reaction of the compounds from step (a) to form a hydroxy compound of formula (VI):

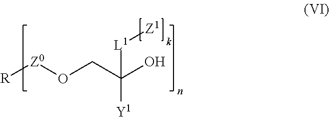

c) Addition of a polyisocyanate of formula (VII):

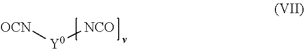

and conversion to form a hybrid-functional polymer of formula (I).

A subject matter of the invention is also the reaction products from this conversion.

Compounds of formula (IIIa) are in particular butadiene/acrylonitrile copolymers, such as are commercially available, for example, under the name Hypro™ (formerly Hycar®) CTBN from Nanoresins AG, Germany or Emerald Performance Materials LLC.

The polymer of formula (IIIa) preferably has a structure of formula (IIIc)

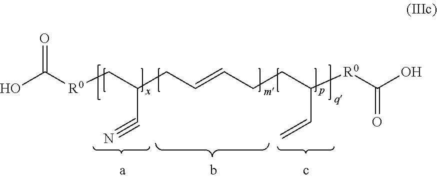

R⁰ stands for a linear or branched alkylene radical with 1 to 6 C atoms, in particular with 5 C atoms, which is optionally substituted with unsaturated groups. In an embodiment that should especially be mentioned, the substituent R⁰ represents a substituent of formula (X), where the dashed lines represent the linkage points:

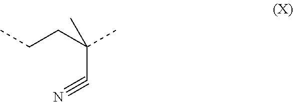

Furthermore, the subscript q′ stands for a number between 40 and 100, in particular between 50 and 90. Furthermore the symbols b and c represent structural elements originating from the butadiene and a represents the structural element originating from the acrylonitrile. The subscripts x, m′, and p in turn represent numbers describing the ratio of the structural elements a, b, and c to each other. The subscript x stands for a number from 0.05-0.3, the subscript m′ stands for numbers from 0.5-0.8, the subscript p stands for a number from 0.1-0.2, assuming that the sum of x, m′, and p is equal to 1. Preferably x<0.26, preferably <0.20.

It is clear to the person skilled in the art that the representations in formula (IIIc) are simplified. Thus the components a, b, and c can each be disposed in a random, alternating, or block manner relative to each other. In particular, formula (IIIc) does not necessarily represent a triblock copolymer.

Especially preferred butadiene/acrylonitrile copolymers are Hypro™ CTBN 1300X31, Hypro™ CTBN 1300X8, Hypro™ CTBN 1300X13, and Hypro™ CTBN 1300X9 from Nanoresins AG, Germany or Emerald Performance Materials LLC.

On the other hand, carboxyl group-terminated polymers can also be obtained by reaction of hydroxyl, amine, or thiol-terminated polymers with dicarboxylic acids or their anhydrides. The carboxyl group-terminated polymers obtainable in this way can be represented by structural formula (IIIb).

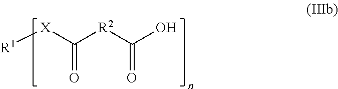

Here X stands for O, S, or NR⁴, and R⁴ stands for H or an alkyl group with 1 to 10 carbon atoms. R¹ stands for an n-valent radical of a polymer R¹—[XH]ₙ after removal of the terminal —XH groups. R² stands for a dicarboxylic acid radical after removal of the two carboxyl groups, in particular for a saturated or unsaturated, optionally substituted alkylene group with 1 to 6 carbon atoms or an optionally substituted phenylene group.

In a second embodiment, hydroxyphenyl-terminated polymers can be used to prepare polymers of formula (I), as are obtained by reaction of hydroxyl terminated, amine-terminated, or thiol-terminated polymers with hydroxyphenyl-functional carboxylic acids or their esters. The hydroxyphenyl-terminated polymers obtainable in this way can be represented by structural formula (IVa).

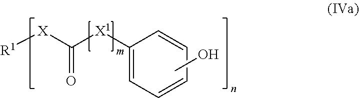

Then X¹ stands for NR⁴, CH₂, or C₂H₄ and m stands for 0 or 1. R¹, X, NR⁴, and n have already been defined above.

But it is understood that preparation of the polymer with at least two carboxyl and/or phenol groups is not limited to the synthesis routes indicated above, and the person skilled in the art can always use alternative methods.

R¹ or R preferably stands for a poly(oxyalkylene) polyol, polyester polyol, poly(oxyalkylene) polyamine, polyalkylene polyol, polycarbonate polyol, polymercaptan, or polyhydroxy polyurethane after removal of the hydroxyl, amine, or mercaptan groups.

In one embodiment, R¹ or R is a polyol after removal of the hydroxyl groups. Such polyols are preferably dials or triols, in particular
polyoxyalkylene polyols, also called polyether polyols, which are the polymerization product of ethylene oxide, 1,2-propylene oxide, 1,2- or 2,3-butylene oxide, oxetane, tetrahydrofuran or mixtures thereof, optionally polymerized using an initiator molecule having two or three active H atoms such as, for example, water or compounds having two or three OH groups. Polyoxyalkylene polyols also can be used that have a low degree of unsaturation (measured according to ASTM D-2849-69 and expressed in milliequivalents of unsaturation per gram polyol (meq/g)), synthesized for example using double metal cyanide complex catalysts (DMC catalysts for short), as well as polyoxyalkylene polyols with a higher degree of unsaturation, synthesized for example using anionic catalysts such as NaOH, KOH, or alkali metal alkoxides. Polyoxypropylene diols and triols are especially suitable which have a degree of unsaturation below 0.02 meq/g and a molecular weight in the range from 300 to 20 000 daltons, polyoxybutylene diols and triols, polyoxypropylene diols and triols with a molecular weight from 400 to 8000 daltons, as well as “EO-endcapped” (ethylene oxide-endcapped) polyoxypropylene diols or triols. The latter are special polyoxypropylene polyoxyethylene polyols that, for example, can be obtained by alkoxylating pure polyoxypropylene polyols with ethylene oxide, after completion of polypropoxylation, and thus have primary hydroxyl groups.
hydroxy-terminated polybutadiene polyols such as, for example, those that can be synthesized by polymerization of 1,3-butadiene and allyl alcohol or by oxidation of polybutadiene, as well as their hydrogenation products;
styrene/acrylonitrile-grafted polyether polyols, such as supplied, for example, by Elastogran under the name Lupranol®;
polyester polyols, synthesized for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, reacted with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone;
polycarbonate polyols, as can be obtained, for example, by reaction of the above-indicated alcohols (used to synthesize the polyester polyols) with dialkyl carbonates, diaryl carbonates, or phosgene;
1,2-ethanediol, diethylene glycol, 1,2-propanediol, dipropylene glycol, 1,4-butanediol, 1,5-pentanediol, 1,6-hexanediol, 1,7-heptanediol, octanediol, nonanediol, decanediol, neopentyl glycol, pentaerythritol 2,2-bis(hydroxymethyl)-1,3-propanediol), dipentaerythritol (=3-(3-hydroxy-2,2-bis(hydroxymethyl)propoxy-2,2-bis(hydroxymethyl)propan-1-ol), glycerol (=1,2,3-propanetriol), trimethyloipropane (=2-ethyl-2-(hydroxymethyl)-1,3-propanediol), trimethylolethane (=2-(hydroxymethyl)-2-methyl-1,3-propanediol, di(trimethylolpropane) (=3-(2,2-bis(hydroxymethyl)butoxy)-2-ethyl-2-hydroxymethyl-propan-1-ol), di(trimethylolethane) (=3-(3-hydroxy-2-hydroxymethyl-2-methylpropoxy)-2-hydroxymethyl-2-methylpropan-1-ol), diglycerol (=bis(2,3-dihydroxypropyl)ether);
polyols obtained by reduction of dimerized fatty acids.

In another embodiment, R¹ or R is a polyamine after removal of the amino groups. Such polyamines are in particular diamines or triamines, preferably aliphatic or cycloaliphatic diamines or triamines. This includes in particular polyoxyalkylene polyamines with two or three amino groups that can be obtained, for example, under the name Jeffamine® (from Huntsman Chemicals), under the name polyetheramine (from BASF), or under the name PC Amine® (from Nitroil), as well as mixtures of the aforementioned polyamines.

Preferred diamines are polyoxyalkylene polyamines with two amino groups, in particular those having formula (VIII).

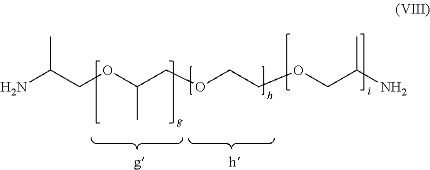

Here g′ represents the structural element originating from propylene oxide, and h′ represents the structural element originating from ethylene oxide. Furthermore, g, h, and i stand for numbers from 0 to 40, provided that the sum of g, h, and i≧1.

Molecular weights between 200 and 10 000 g/mol are particularly preferred.

Particularly preferred diamines are Jeffamine®, as are sold as the D line and the ED line by Huntsman Chemicals, such as, for example, Jeffamine® D-230, Jeffamine® D-400, Jeffamine° D-2000, Jeffamine® D-4000, Jeffamine® ED-600, Jeffamine® ED-900, or Jeffamine® ED-2003.

Furthermore, preferred triamines are marketed, for example, as the Jeffamine® T line from Huntsman Chemicals, such as, for example, Jeffamine® T-3000, Jeffamine® T-5000 or Jeffamine® T-403.

In a further embodiment, R¹ or R is a polymercaptan after removal of the mercapto groups. Suitable polymercaptans are, for example, polymercaptoacetates of polyols. Here these are in particular polymercaptoacetates of the following polyols:
polyoxyalkylene polyols, also called polyether polyols, which are the polymerization product of ethylene oxide, 1,2-propylene oxide, 1,2- or 2,3-butylene oxide, tetrahydrofuran or mixtures thereof, optionally polymerized using an initiator molecule having two or three active H atoms such as, for example, water or compounds having two or three OH groups. Polyoxyalkylene polyols can be used that have a low degree of unsaturation (measured according to ASTM D-2849-69 and expressed in milliequivalents of unsaturation per gram polyol (meq/g)), synthesized for example using “double metal cyanide complex catalysts” (DMC catalysts for short), as well as polyoxyalkylene polyols with a higher degree of unsaturation, synthesized for example using anionic catalysts such as NaOH, KOH, or alkali metal alkoxides. Polyoxypropylene diols and triols are especially suitable which have a degree of unsaturation below 0.02 meq/g and a molecular weight in the range from 300 to 20 000 daltons, polyoxybutylene diols and triols, polyoxypropylene diols and triols with a molecular weight from 400 to 8000 daltons, as well as “EO-endcapped” (ethylene oxide-endcapped) polyoxypropylene diols or triols.
The latter are special polyoxypropylene polyoxyethylene polyols that, for example, are obtained by alkoxylating pure polyoxypropylene polyols with ethylene oxide, after completion of polypropoxylation, and thus have primary hydroxyl groups.
hydroxy-terminated polybutadiene polyols such as, for example, those that are synthesized by polymerization of 1,3-butadiene and allyl alcohol or by oxidation of polybutadiene, as well as their hydrogenation products;
styrene/acrylonitrile-grafted polyether polyols, such as supplied, for example, by Elastogran under the name Lupranol®;
polyester polyols, synthesized for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, reacted with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone;
polycarbonate polyols, as can be obtained, for example, by reaction of the above-indicated alcohols (used to synthesize the polyester polyols) with dialkyl carbonates, diaryl carbonates, or phosgene;
1,2-ethanediol, diethylene glycol, 1,2-propanediol, dipropylene glycol, 1,4-butanediol, 1,5-pentanediol, 1,6-hexanediol, 1,7-heptanediol, octanediol, nonanediol, decanediol, neopentyl glycol, pentaerythritol (=2,2-bis(hydroxymethyl)-1,3-propanediol), dipentaerythritol (=3-(3-hydroxy-2,2-bis(hydroxymethyl)propoxy-2,2-bis(hydroxymethyl)propan-1-ol), glycerol (=1,2,3-propanediol), trimethylolpropane (=2-ethyl-2-(hydroxymethyl)-1,3-propanediol), trimethylolethane (=2-(hydroxymethyl)-2-methyl-1,3-propanediol, di(trimethylolpropane) (=3-(2,2-bis(hydroxymethyl)butoxy)-2-ethyl-2-hydroxymethyl-propan-1-ol), di(trimethylolethane) (=3-(3-hydroxy-2-hydroxymethyl-2-methylpropoxy)-2-hydroxymethyl-2-methylpropan-1-ol), diglycerol (=bis(2,3-dihydroxypropyl)ether);
polyols such as are obtained by reduction of dimerized fatty acids.

Glycol dimercaptoacetate, trimethylolpropane trimercaptoacetate, and butanediol dimercaptoacetate are particularly preferred.

Dimercaptans of formula (IX) are the most preferred polymercaptans.

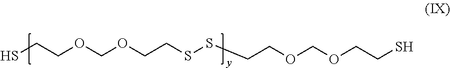

Here y stands for a number from 1 to 45, in particular from 5 to 23. The preferred molecular weights are between 800 and 7500 g/mol, in particular between 1000 and 4000 g/mol. Such polymercaptans are commercially available as the Thiokol® LP line of Toray Fine Chemicals Co.

According to a further embodiment, the carboxyl group-terminated or phenol group-terminated polymer of formula (IIIb) (IV), or (IVa) is prepared by reaction of at least one hydroxyl-functional, amine-functional, or thiol-functional polymer with at least one hydroxyphenyl-functional carboxylic acid or esters or lactones thereof, or with benzoxazolinone, or with at least one dicarboxylic acid or a dicarboxylic acid anhydride.

Preferred hydroxyphenyl-functional carboxylic acids are ortho-, meta-, or para-hydroxybenzoic acid or 2-, 3-, or 4-hydroxyphenylacetic acid or 2-, 3-, or 4-hydroxyphenylpropionic acid.

Preferred hydroxyphenyl-functional carboxylic acids are ortho-, meta-, or para-hydroxybenzoic acid methyl ester, ortho-, meta-, or para-hydroxybenzoic acid ethyl ester, ortho-, meta-, or para-hydroxybenzoic acid isopropyl ester.

Preferred lactones of hydroxyphenyl-functional carboxylic acids are benzofuran-2-one, benzodihydropyrone (=dihydrocoumarin).

Preferred dicarboxylic acid anhydrides are phthaiic acid anhydride, maleic acid anhydride, succinic acid anhydride, methylsuccinic acid anhydride, isobutenylsuccinic acid anhydride, phenylsuccinic acid anhydride, itaconic acid anhydride, cis-1,2,3,6-tetrahydrophthalic acid anhydride, hexahydrophthalic acid anhydride, norbornan-2,3-dicarboxylic acid anhydride, hexahydro-4-methylphthalic acid anhydride, glutaric acid anhydride, 3-methylgiutaric acid anhydride, (±)-1,8,8-trimethyl-3-oxabicyclo[3.2.1]octane-2,4-dione, oxepan-2,7-dione.

This reaction to prepare the polymer of formula (IIIa), (IIIb), or (IV) is preferably carried out in the presence of a catalyst at elevated temperatures of 50° C. to 150° C., preferably 70° C. to 130° C. Triphenylphosphine is preferably used as the catalyst; the reaction can optionally be carried out under protective gas or vacuum. Examples of other catalysts that can be used are tertiary amines, quaternary phosphonium salts, or quaternary ammonium salts. This reaction can also be carried out without any catalyst, but then the reaction is run at elevated temperatures of 80° C. to 200° C., preferably 90° C. to 180° C. A molar excess of epoxy groups compared with carboxyl and/or phenol groups in the reaction mixture is preferably selected. Here the ratio of the number of epoxy groups compared with the number of carboxyl and/or phenol groups is 1:1 to 50:1, preferably 1:1 to 20:1, especially preferably 1:1 to 10:1.

In a preferred embodiment, a diisocyanate or a triisocyanate is used as the polyisocyanate of formula (VII).

Aliphatic, cycloaliphatic, or aromatic polyisocyanates, in particular diisocyanates, can be used as the polyisocyanates. The following are particularly suitable:
1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and -1,4-diisocyanate and any mixture of these isomers, 1-methyl-2,4- and -2,6-diisocyanatocyclohexane and any mixture of these isomers (HTDI or H₆TDI), 1-isocyanato-3,3,5-trimethyl-5-isocyanatomethylcyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3- and -1,4-xylylene diisocyanate (m- and p-TMXDI), bis(1-isocyanato-1-methylethyl)naphthalene.
2,4- and 2,6-toluoylene diisocyanate and any mixture of their isomers (TDI), 4,4′-, 2,4′, and 2,2′-diphenylmethane diisocyanate and any mixtures of these isomers (MDI), 1,3- and 1,4-phenylene diisocyanate, 2,3,5,6-tetramethyl-1,4-diisocyanatobenzene, naphthalene-1,5-diisocyanate (NDI) 3,3′-dimethyl-4,4′-diisocyanatodiphenyl (TODI), dianisidine diisocyanate (DADI).
oligomers (e.g., biurets, isocyanurates) and polymers of the aforementioned monomeric diisocyanates.
Any mixtures of the aforementioned polyisocyanates.

Monomeric diisocyanates are preferred, in particular MDI, TDI, HDI, and IPDI.

The polyisocyanate of formula (VII) is used in particular in an amount such that the ratio of NCO groups to OH groups in the described polymer of formula (VI) having hydroxyl groups is ≧1.1 to 32, so that isocyanate group-terminated polyaddition products are formed. Especially suitable are such polyaddition products which are formed from an NCO/OH ratio between 1.5 and 2.

It is clear to the person skilled in the art that the amount of polyisocyanate of formula (VII) should be appropriately increased if other NCO reactive compounds, for example the isocyanate-reactive polymers of formula (XI) described below, are present in this reaction.

In a variant of the preparation method according to the invention, in the reaction of at least one polymer of formula (VI) with at least one polyisocyanate of formula (VII), at least one other isocyanate-reactive polymer is additionally present. This isocyanate-reactive polymer is preferably selected from the group consisting of poly(oxyalkylene) polyol, polyester polyol, polycarbonate polyol, poly(oxyalkylene) polyamine, polyalkylene polyol, and polymercaptan. Regarding examples of these groups of substances, refer to the above embodiments for R¹ or R¹—[XH]ₙ.

Preferably polymer (VI) and the other isocyanate-reactive polymer(s) are present in a mix ratio by weight from 1:100 to 100:1.

As mentioned above, the isocyanate group-terminated polyaddition product according to the invention can be used in particular in adhesives, and in this respect the present invention relates to an adhesive composition containing the latter polyaddition product.

Because of its special properties, the present invention includes use of the polymer of formula (VI) in polyurethane chemistry, preferably as a curing agent component or as part of a curing agent component in two-component adhesives. Additionally, many other applications are conceivable, for example, in polyurethanes for seals, tubing, flooring, lacquers, sealants, skis, textile fibers, tracks in stadiums, potting compounds, and many more.

In a preferred embodiment of the invention, in step (a) the epoxy compound of formula (V) is added in stoichiometric excess relative to the carboxyl groups. The stoichiometric excess is, for example, 1% to 50%.

The reaction is preferably carried out in the presence of a catalyst. The reaction is preferably carried out at elevated temperature. For example, the temperature can range between 50° C. and 200° C., in particular between 80° C. and 150° C.

The epoxy compound of formula (V) has a functional group Z¹, for example, selected from the group consisting of (meth)acrylate, silyl, vinyl, allyl, nitrile, and epoxy groups. In a further preferred embodiment of the invention, the epoxy compound of formula (V) is a functionalized glycidyl ether compound, which for example is substituted by one of the latter functional groups.

The functionalized glycidyl group used according to the invention is preferably a functionalized glycidyl ether, glycidyl ester, glycidyl amine, glycidyl amide, or glycidyl imide.

The glycidyl compound can also contain more than one glycidyl group. The synthesis of a hydroxyl-terminated polymer of formula (VI) according to the invention then is preferably carried out in a way such that only one glycidyl group each reacts per glycidyl compound. The at least one other glycidyl group then remains as the functional group Z¹ in the hydroxyl-functional polymer, which thus has an epoxy functional group. This can be achieved, for example, if the glycidyl compound is used in excess.

A subject matter of the invention is also a method for preparation of a hybrid-functional polymer as in formula (II), including the steps:
α) Preparation of a hybrid-functional polymer of formula (I) and/or a product made by the method according to the invention for preparation of a compound as in formula (I),
β) Addition of a compound of formula HX⁰ or HX′-L²-[Z²]_{k′}, and conversion to a hybrid-functional polymer of formula (II).

In order to obtain an efficient yield of formula (II), preferably the compound HX⁰ or HX′-L²-[Z²]_{k′} is used in at least stoichiometric ratio, preferably in stoichiometric excess of the HX⁰ or HX′ groups compared with the isocyanate groups of formula (I).

Z² stands for a functional group which is different from Z¹ and different from NCO. It is clear to the person skilled in the art that in fact it would also be possible in principle to use a corresponding compound with terminal group Z¹ in step (β), but that in this case no hybrid-functional polymer of formula (II) would be formed, such a polymer would not be according to the invention and therefore also would not have the advantages mentioned.

The group Z² is not reactive with isocyanate groups or is less reactive than the group HX′. In order to make sure that a polymer of formula (II) is formed, the group Z² must be less reactive than the group HX′. The group Z² is preferably not reactive with isocyanate groups. N-phenylethylenediamine is an example of an HX′-L²-[Z²]_{k′} compound in which the group Z² is less reactive than the group HX′

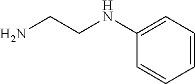

The primary aliphatic amino group of this compound is considerably more reactive with isocyanates than the secondary aromatic amino group. Therefore, when used in a stoichiometric excess it will react with the hybrid-functional polymer of formula (I) with the primary amino group as in step (β) and forms, therefore, in this polymer the following end group X⁰

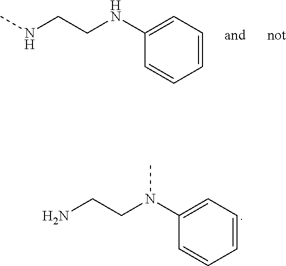

A subject matter of the invention is also a composition containing a hybrid-functional polymer according to the invention.

Generally the hybrid-functional polyisocyanates of formula (I) according to the invention can be converted with suitable reactants, for example with hydroxy-terminated epoxides, hydroxyl-terminated methacrylates, aminosilanes, thermally labile blocking agents, etc. In this way, very different hybrid-functional polymers of formula (II) can be obtained. Preferred “hybrid functional groups” are, for example, epoxy/isocyanate, (meth)acrylate/isocyanate, (meth)acrylate/blocked isocyanate, (meth)acrylate/epoxy, epoxy/blocked isocyanate, epoxy/silane, and (meth)acrylate/silane.

Because of the hybrid character of the hybrid-functional polymers of formulas (I) and (II), such polymers or their compositions can be used in systems which have two different reaction mechanisms. Such systems are known to the person skilled in the art as “dual-cure” systems. Therefore such polymers are suitable in particular for two-step curing, i.e., curing processes in which one functional groups leads to a fast reaction or curing and the other functional group leads to a slow reaction.

For example, for hybrid-functional polymers with NCO groups or with alkoxysilane, the slow crosslinking reaction can be the reaction of the NCO groups with moisture in the air, while the fast reaction can be a reaction through an addition reaction or a polymerization reaction of the second functional group, in particular epoxy or (meth)acrylate or vinyl or allyl groups. For example, such a dual-cure system in a system consisting of two components can be achieved in which at least the hybrid-functional polymer is present in the first component and either a polymerization initiator or an addition agent is present in the second component.

Specific examples are:

| First Component | |
|---|---|
| (functional groups | |
| of polymer of | |
| formula (I)/(II)) | Second Component |
| NCO/(meth)acrylate | Peroxide: Radical initiator for |
| | crosslinking (meth)acrylate |
| Silane/(meth)acrylate | Peroxide: Radical initiator for |
| | crosslinking (meth)acrylate |
| NCO/vinyl | Peroxide: Radical initiator for |
| | crosslinking vinyl |
| Silane/vinyl | Peroxide: Radical initiator for |
| | crosslinking vinyl |
| Silane/amine | Polyepoxide: Addition to amine |
| Silane/amine | Polyisocyanate: Addition to amine |
| Silane/epoxy | Polyamine: Addition to epoxy |
| Epoxy/(meth)acrylate | Polyamine: Addition to epoxy (slow); |
| | Addition to (meth)acrylate (fast) |
| Epoxy/(meth)acrylate | Polyamine: Addition to epoxy (slow) |
| | Peroxide: Radical initiator for |
| | crosslinking (meth)acrylate (fast) |
| Hydroxyl/(meth)acrylate | Polyisocyanate: Addition to hydroxyl |
| | (fast) |
| | Peroxide: Radical initiator for |
| | crosslinking (meth)acrylate |
| | (very fast) |

Two-component dual-cure systems can also be realized by crosslinking one functional group of the hybrid-functional polymer of formula (I) or (II) via a reaction occurring at room temperature (RT) and crosslinking the other functional group via a reaction inhibited at room temperature and only occurring at elevated temperature. Specific examples of this are:

| First Component | |
|---|---|
| (functional groups | |
| of polymer of | |
| formula (I)/(II)) | |
| Additional ingredients | Second Component |
| Epoxy/(meth)acrylate | Peroxide: Radical initiator for RT |
| Blocked amine | crosslinking of (meth)acrylate |
| Hydroxyl/epoxy | Polyisocyanate: RT-addition to hydroxyl |
| Blocked amine | |
| Epoxy/blocked NCO | Polyamine: RT addition to epoxy |
| | With heating: Deblocking of NCO groups |
| | and reaction with OH groups formed from |
| | epoxy/polyamine reaction |
| Methacrylate/blocked | Peroxide: Radical initiator for RT |
| NCO Hydroxy-functional | crosslinking of (meth)acrylate and |
| (meth)acrylate | hydroxy-functional (meth)acrylate |
| | With heating: Deblocking of NCO groups |
| | and reaction with OH groups of |
| | copolymerized hydroxy-functional |
| | (meth)acrylate |

One-component dual-cure systems can also be realized where reaction of one functional group of the hybrid-functional polymer of formula (I) or (II) occurs via a reaction proceeding at room temperature (RT) and reaction of the other functional group occurs via a reaction inhibited at room temperature and only proceeding at elevated temperature. Specific examples of this are:

| Functional groups | |
|---|---|
| of polymer of | |
| formula (I) and (II) | Thermally activated curing agent |
| Epoxy/(meth)acrylate | Blocked amine: With heating: Curing of |
| | epoxy via blocked amine |
| | NCO: Slow curing with moisture from air |

Finally, one-component dual-cure systems can also be realized when one functional group of the hybrid-functional polymer of (II) has blocked functionality at room temperature, where the blocking group is cleaved only at temperatures above 100° C., and the second functional group reacts only at elevated temperature with a heat-activated curing agent. Specific examples of this are:

| Functional groups | |
|---|---|
| of polymer of | |
| formula (II) | Thermally activated curing agent |
| Epoxy/blocked NCO | Blocked amine: With heating: Curing of |
| | epoxy via blocked amine |
| | With heating: Deblocking of NCO groups |
| | and reaction |

A subject matter of the invention is also the use of a hybrid-functional polymer according to the invention for preparation of coatings, adhesives, or sealants. Suitable adhesives are, for example, epoxy-, polyurethane-, silane-terminated polymers (STP) and acrylate adhesives, as well as use as primers and activators. Use as a dual-cure adhesive is preferred, i.e., as a two-step curing adhesive. The polymers can also be used for toughness modification.

A further subject matter of the invention is a method for preparation of coatings, adhesives, or sealants, wherein a hybrid-functional polymer according to the invention is mixed with at least one other component and a crosslinking reaction is carried out.

A subject matter of the invention is also a composite which is obtained by adhesive bonding of at least two substrates by means of a composition according to the invention.

### EXEMPLARY EMBODIMENTS

The following Examples serve only for illustration of the invention described above in detail, and do not limit the invention in any way. The headings in each case indicate the functional groups of the polymers.

### Exemplary Embodiments 1 to 4

Examples 1 to 4 illustrate by example the synthesis of hydroxy compounds of formula (VI) from carboxylic acid-terminated polymers and functional epoxides.

### Exemplary Embodiment 1

### Epoxy/Hydroxyl

350 g Hypro™ 1300X13 (acid value of approximately 32.0 mg KOH/g), 525 g Epilox A 17-01 (Leuna-Harze, distilled bisphenol A diglycidyl ether, epoxide content of approximately 5.75 eq/kg), 0.44 g butylhydroxytoluene (BHT) (radical scavenger) and 1.75 g triphenylphosphine were mixed together. The mixture was stirred for 5 h at 120° C. under vacuum, until a constant epoxide concentration was achieved (final epoxide content 3.26 eq/kg; theoretical: 3.22 eq/kg). Thus a viscous polymer was obtained with an OH value of approximately 12.8 mg KOH/g.

This hybrid-functional polymer can be used, for example, for preparation of PUR polymers or for epoxy resin polymers.

### Exemplary Embodiment 2

### Epoxy/Hydroxyl

600 g of the polyether polyol PolyTHF® 2000 (BASF, OH value of approximately 57.0 mg KOH/g) and 90.3 g phthalic acid anhydride were mixed together. The mixture was stirred at 150° C. for 2 h under a nitrogen atmosphere and for 30 min under vacuum. A polymer with an acid value of 49.3 mg KOH/g (theoretical: 49.5 mg KOH/g) was obtained. 200 g of this carboxylic acid-terminated polymer was mixed with 300 g Epilox A 17-01 (distilled bisphenol A diglycidyl ether, epoxide content of approximately 5.75 eq), and 1.0 g triphenylphosphine). The mixture was stirred for 5 h at 120° C. under vacuum, until a constant epoxide concentration was achieved (final epoxide content: 3.12 eq/kg; theoretical: 3.10 eq/kg).

Thus a viscous polymer was obtained with an OH value of approximately 19.7 mg KOH/g.

This hybrid-functional polymer can be used, for example, for preparation of PUR polymers or for epoxy resin polymers.

### Exemplary Embodiment 3

### Methacrylate/Hydroxyl

600 g of the polyether polyol PolyTHF® 2000 (OH value of approximately 57.0 mg/g KOH) and 90.3 g phthalic acid anhydride were mixed together. The mixture was stirred at 150° C. for 2 h under a nitrogen atmosphere and for 30 min under vacuum. A polymer with an acid value of 49.3 mg KOH/g (theoretical: 49.5 mg KOH/g) was obtained. 130 g of this carboxylic acid-terminated polymer was mixed with 18.4 g glycidyl methacrylate (epoxide content of approximately 7.03 eq), 0.15 g butylhydroxytoluene (BHT), and 0.29 g triphenylphosphine. The mixture was stirred for 5 h at 120° C. in air, until a constant epoxide concentration was achieved (final epoxide content: 0.08 eq/kg; theoretical: 0.11 eq/kg). Then the mixture was deaerated under vacuum for 10 minutes. Thus a viscous polymer was obtained with an OH value of approximately 42.5 mg KOH/g.

This hybrid-functional polymer can be used, for example, for preparation of PUR polymers or for (meth)acrylic resin polymers.

### Exemplary Embodiment 4

### Methacrylate/Hydroxyl

250 g Dynacoll® 7380 AC-28 (Degussa, acid value of approximately 29.0 mg KOH/g), 21.1 g glycidyl methacrylate (epoxide content of approximately 7.03 eq/kg), 0.27 g BHT, and 0.54 g triphenylphosphine were mixed together. The mixture was stirred for 3 h at 120° C. in air, until a constant epoxide concentration was achieved (final epoxide content: 0.25 eq/kg; theoretical: 0.07 eq/kg). Then the mixture was deaerated under vacuum for 10 minutes. Thus a viscous polymer was obtained with an OH value of approximately 26.7 mg KOH/g.

This hybrid-functional polymer can be used, for example, for preparation of PUR polymers or for methacrylic resin polymers.

### Exemplary Embodiments 5 to 8

Exemplary embodiments 5 to 8 illustrate synthesis of hybrid-functional polymers of formula (I) with terminal isocyanate groups.

### Exemplary Embodiment 5

### Epoxy/Isocyanate

310 g of the polyol synthesized according to exemplary embodiment 1 (OH value of approximately 12.8 mg KOH/g), 18.0 g isophorone diisocyanate (IPDI), 0.15 g BHT (radical scavenger), and 0.07 g dibutyltin dilaurate were mixed together. The mixture was stirred for 2 h at 90° C. under vacuum, and then a viscous NCO-terminated polymer was obtained (final NCO content: 0.95%; theoretical 1.07%). This NCO-terminated polymer can be used, for example, for preparation of PUR polymers or for epoxy resin formulations.

### Exemplary Embodiment 6

### Epoxy/Isocyanate

300 g of the polyol synthesized according to exemplary embodiment 2 (OH value of approximately 19.7 mg KOH/g), 26.0 g IPDI, 0.16 g BHT (radical scavenger), and 0.08 g dibutyltin dilaurate were mixed together. The mixture was stirred for 2 h at 100° C. h under vacuum, and then a viscous NCO-terminated polymer was obtained (final NCO content: 1.26%; theoretical 1.56%).

This NCO/epoxy-terminated polymer can be used, for example, for preparation of PUR formulations or for epoxy resin formulations.

### Exemplary Embodiment 7

### Methacrylate/Isocyanate

240 g of the polyol synthesized according to exemplary embodiment 3 (OH value of approximately 42.5 mg KOH/g), 42.8 g IPDI, 0.24 g BHT (radical scavenger), and 0.06 g dibutyltin dilaurate were mixed together. The mixture was stirred for 2 h at 90° C. under vacuum, and then a viscous NCO-terminated polymer was obtained (final NCO content: 3.15%; theoretical 2.95%).

This NCO/methacrylate-terminated polymer can be used, for example, for preparation of PUR formulations or for epoxy resin formulations.

### Exemplary Embodiment 8

### Methacrylate/Isocyanate

150 g of the polyol synthesized according to exemplary embodiment 4 (OH value of approximately 26.7 mg KOH/g), 16.6 g IPDI, 0.08 g BHT (radical scavenger), and 0.03 g dibutyltin dilaurate were mixed together. The mixture was stirred for 2 h at 90° C. under vacuum, and then a viscous NCO-terminated polymer was obtained (final NCO content: 2.25%; theoretical 1.89%).

This NCO/methacrylate-terminated polymer can be used, for example, for preparation of PUR formulations or for methacrylic resin formulations.

### Exemplary Embodiments 9 to 15

Exemplary embodiments 9 to 15 illustrate the synthesis of hybrid-functional polymers of formula (II).

### Exemplary Embodiment 9

### Epoxy/Blocked Isocyanate

100 g of the hybrid polymer synthesized according to exemplary embodiment 5 (NCO content of approximately 0.95%) and 16.3 g Cardolite NC-700 (cardanol, Cardiolite) were mixed together. The mixture was stirred for 3 h at 100° C. h under vacuum, until the NCO content dropped below 0.1%.

This hybrid-functional polymer can be used alone or in blends for preparation of adhesives, insulating materials, coatings, primers, etc.

### Exemplary Embodiment 10

### Epoxy/Methacrylate

100 g of the hybrid polymer synthesized according to exemplary embodiment 5 (NCO content of approximately 0.95%) and 3.6 g hydroxyethyl methacrylate (HEMA) were mixed together. The mixture was stirred for 2 h at 90° C. in air, until the NCO content dropped below OA %.

Then the mixture was degassed under vacuum for 10 minutes.

This hybrid-functional polymer can be used alone or in blends for preparation of adhesives, insulating materials, coatings, primers, etc.

### Exemplary Embodiment 11

### Epoxy/Silane

A total of 3.9 g of 3-aminopropyltrimethoxysilane (Silquest A-1110) was added dropwise with constant stirring at 90° C. to 100 g of the hybrid polymer synthesized according to exemplary embodiment 5 (NCO content of approximately 0.95%). The mixture was then stirred for 2 h at 90° C. under vacuum, until the NCO content dropped below 0.1%.

This hybrid-functional polymer can be used alone or in blends for preparation of adhesives, insulating materials, coatings, primers, etc.

### Exemplary Embodiment 12

### Epoxy/Blocked Isocyanate

162 g of the hybrid polymer synthesized according to exemplary embodiment 6 (NCO content of approximately 1.26%) and 19 g Cardolite NC-700 were mixed together. The mixture was stirred for 3 h at 100° C. h under vacuum, until the NCO content dropped below 0.1%.

This hybrid-functional polymer can be used alone or in blends for preparation of adhesives, insulating materials, coatings, primers, etc.

### Exemplary Embodiment 13

### Methacrylate/Epoxy

137 g of the hybrid polymer synthesized according to exemplary embodiment 7 (NCO content of approximately 3.15%) and 68.7 g Polypox R20 (mixture of trimethylolpropane diglycidyl ether and trimethylolpropane triglycidyl ether) were mixed together.

The mixture was then stirred for 2 h at 90° C. in air, until the NCO content dropped below 0.1%. Then the mixture was degassed under vacuum for 10 minutes.

This hybrid-functional polymer can be used alone or in blends for preparation of adhesives, insulating materials, coatings, primers, etc.

### Exemplary Embodiment 14

### Methacrylate/Silane

A total of 14.4 g of 3-aminopropyltrimethoxysilane (Silquest A-1110) was added dropwise with constant stirring at 90° C. to 110 g of the hybrid polymer synthesized according to exemplary embodiment 7 (NCO content of approximately 3.15%). The mixture was then stirred for 2 h at 90° C. in air, until the NCO content dropped below 0.1%. Then the mixture was degassed under vacuum for 10 minutes.

This hybrid-functional polymer can be used alone or in blends for preparation of adhesives, insulating materials, coatings, primers, etc.

### Exemplary Embodiment 15

### Methacrylate/Blocked Isocyanate

150 g of the hybrid polymer synthesized according to exemplary embodiment 8 (NCO content of approximately 2.25%) and 13 g benzoxazolinone were mixed together.

The mixture was then stirred for 3 h at 110° C. in air, until the NCO content dropped below 0.2%. Then the mixture was degassed under vacuum for 10 minutes.

This hybrid-functional polymer can be used alone or in blends for preparation of adhesives, insulating materials, coatings, primers, etc.

1. Hybrid-functional polymer of formula (I): 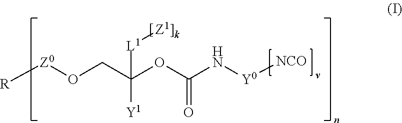
where:
R stands for an n-valent polymer radical;
Z⁰ stands for —CO— or —X—CO—R²—CO— or X—CO—[X¹]ₘA-; where:
X stands for O, NR⁴, or S, where R⁴ in turn stands for H or an alkyl group with 1 to 10 carbon atoms;
X¹ stands for NR⁴, CH₂, or C₂H₄;
m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group; and
A stands for an optionally substituted arylene radical;
Y⁰ stands for a (v+1)-valent polyisocyanate radical after removal of the isocyanate groups;
Y¹ stands for H or for a methyl group;
Z¹ stands for a functional group which is different from NCO and which is not reactive with isocyanate groups;
L¹ stands for a (k+1)-valent organic radical which links the functional group Z¹ to the rest of the molecule of formula (I);
k stands for 1 or 2 or 3;
v stands for 1 or 2 or 3, and
n stands for 2 or 3 or 4.

2. Hybrid-functional polymer of formula (II): 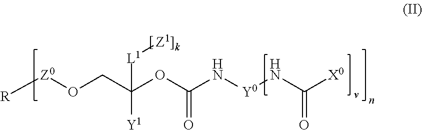
where:
R stands for an n-valent polymer radical;
Z⁰ stands for —CO— or —X—CO—R²—CO— or —X—CO—[X¹]ₘA-; where:
X stands for O, NR⁴, or S, where R⁴ in turn stands for H or an alkyl group with 1 to 10 carbon atoms;
X¹ stands for NR⁴, CH₂, or C₂H₄;
m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group; and
A stands for an optionally substituted arylene radical;
Y⁰ stands for a (v+1)-valent polyisocyanate radical after removal of the isocyanate groups;
Y¹ stands for H or for a methyl group;
Z¹ stands for a functional group which is different from NCO and which is not reactive with isocyanate groups;
L¹ stands for a (k+1)-valent organic radical which links the functional group Z¹ to the rest of the molecule of formula (II);
X⁰ stands for a blocking group different from Z¹ which is cleaved at a temperature above 100° C., or for a radical of formula (II′) 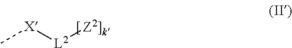
where Z² stands for a functional group which is different from Z¹ and from NCO and which is not reactive with isocyanate groups or is less reactive than the group HX′;
L² stands for a (k′+1)-valent organic radical which links the functional group Z² to the rest of the molecule of formula (II),
X′ stands for O, NH, NR³, or S,
where R³ stands for an alkyl radical that is branched or unbranched and/or saturated or unsaturated, or stands for an aryl or alkaryl radical that is optionally substituted, or stands for a radical of formula -L²-[Z²]_{k′}; and
k′ stands for 1 or 2 or 3;
k stands for 1 or 2 or 3;
v stands for 1 or 2 or 3, and
n stands for 2 or 3 or 4.

3. Hybrid-functional polymer as in claim 1, wherein Z⁰ stands for —CO— and R stands for a carboxyl group-terminated butadiene/acrylonitrile copolymer (CTBN) after removal of the terminal carboxyl groups.

4. Hybrid-functional polymer as in claim 1, wherein Z⁰ stands for —X—CO—R²—CO— and R stands for an n-valent radical of a polymer R¹—[XH]ₙ after removal of n XH groups.

5. Hybrid-functional polymer as in claim 4, wherein R¹ stands for a poly(oxyalkylene) polyol, polyester polyol, poly(oxyalkylene) polyamine, polyalkylene polyol, polycarbonate polyol, polymercaptan, or polyhydroxy polyurethane, or hydroxyl-terminated polysiloxane after removal of the hydroxyl, amine, or mercaptan groups.

6. Hybrid-functional polymer as in claim 1, wherein Z⁰ stands for —X—CO—[X¹]ₘA- and A stands for a phenylene group.

7. Hybrid-functional polymer as in claim 1, wherein Z¹ is selected from the group consisting of (meth)acrylate, silane, vinyl, allyl, nitrile, and epoxy.

8. Hybrid-functional polymer as in claim 1, wherein L¹ stands for a methylene group.

9. Hybrid-functional polymer as in claim 1, wherein Y⁰ stands for a polycyanate after removal of the isocyanate groups, where the polyisocyanate is selected from the group consisting of 1,6-hexamethylene diisocyanate (HDI), 1-isocyanato-3,3,5-trimethyl-5-isocyanatomethylcyclohexane (=isophorone diisocyanate or IPDI), 2,4- and 2,6-toluoylene diisocyanate and any mixtures of these isomers (TDI), 4,4′-, 2,4′-, and 2,2′-diphenylmethane diisocyanate and any mixtures of these isomers (MDI), biurets of the aforementioned polyisocyanates, uretdiones of the aforementioned polyisocyanates, and isocyanurates of the aforementioned polyisocyanates.

10. Hybrid-functional polymer as in claim 2, wherein Z² is selected from the group consisting of isocyanate, epoxy, glycidyl, amine, (meth)aerylate, silane, vinyl, allyl, and nitrile.

11. Hybrid-functional polymer as in claim 2, wherein X⁰ stands for a radical selected from the group consisting of 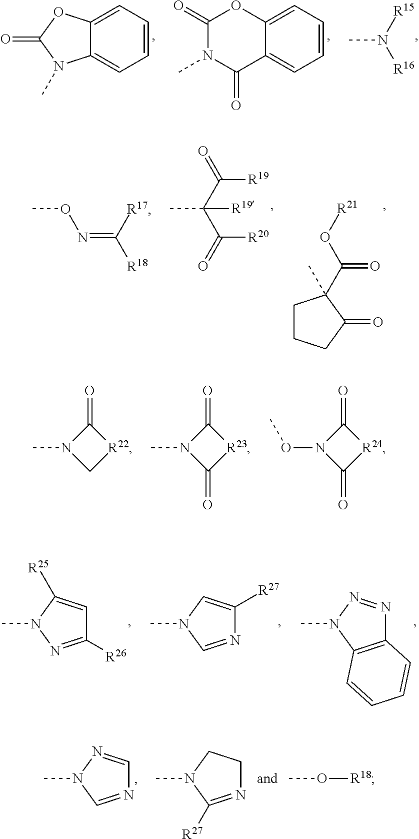
where:
R¹⁵, R¹⁶, R¹⁷, and R¹⁸ each independently stands for an alkyl or cycloalkyl or aryl or aralkyl or arylalkyl group or else R¹⁵ together with R¹⁶, or R¹⁷ together with R¹⁸ form part of a 4- to 7-membered ring, which is optionally substituted;
R¹⁹R^{19′}, and R²⁰ each independently stands for an alkyl or aralkyl or aryl or arylalkyl group or for an alkyloxy or aryloxy or aralkyloxy group;
R²¹ stands for an alkyl group;
R²², R²³, and R²⁴ each independently stands for an alkylene group with 2 to 5 C atoms, which optionally has double bonds or is substituted, or for a phenylene group or for a hydrogenated phenylene group;
R²⁵, R²⁶, and R²⁷ each independently stands for H or for an alkyl group or for an aryl group or an aralkyl group; and
R²⁸ stands for an aralkyl group or for a mononuclear or polynuclear substituted or unsubstituted aromatic group, which optionally has aromatic hydroxyl groups.

12. Method for preparation of a hybrid-functional polymer as in claim 1, comprising steps:
a) preparing a polymer selected from the group consisting of a carboxyl group-terminated polymer of formula (IIIa), a carboxyl group-terminated polymer of formula (IIIb), a phenol group-terminated polymer of formula (IV), a phenol group-terminated polymer of formula (IVa), and an epoxy compound of formula (V): 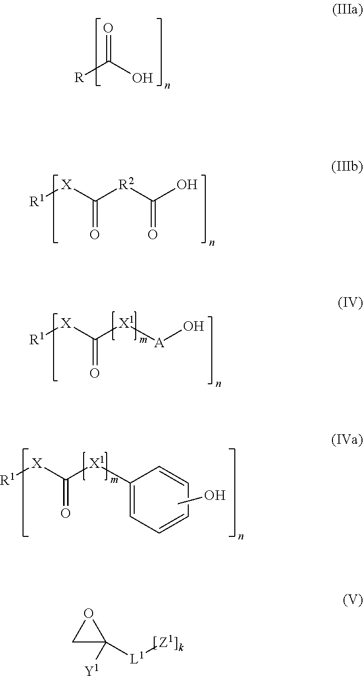
b) reacting the compound from step (a) to form a hydroxy compound of formula (VI): 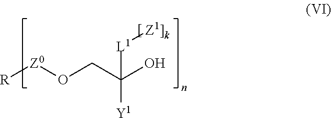
c) adding a polyisocyanate of formula (VII): 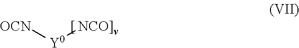
and converting to the hybrid-functional polymer of formula (I).

13. Method as in claim 12, wherein during step (a) the epoxy compound of formula (V) is added in stoichiometric excess.

14. Method as in claim 12, wherein the epoxy compound of formula (V) is a glycidyl ether compound.

15. Method as in claim 12, further comprising the steps:
α) preparing the hybrid-functional polymer of formula (I),
β) adding a compound of formula HX⁰ or HX′-L²-[Z²]_{k′}, and converting to a hybrid-functional polymer of formula (II): 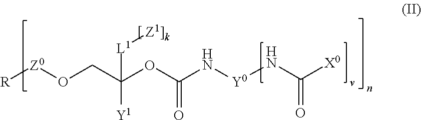
where:
R stands for an n-valent polymer radical:
Z⁰ stands for —CO— or —X—CO—R²—CO— or —X—CO—[X¹]ₘA-; where:
X stands for O, NR⁴, or S, where R⁴ in turn stands for H or an alkyl group with 1 to 10 carbon atoms;
X¹ stands for NR⁴, CH₂, or C₂H₄;
m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group; and
A stands for an optionally substituted arylene radical;
Y⁰ stands for a (v+1)-valent polyisocyanate radical after removal of the isocyanate groups;
Y¹ stands for H or for a methyl group;
Z¹ stands for a functional group which is different from NCO and which is not reactive with isocyanate groups;
L¹ stands for a (k+1)-valent organic radical which links the functional group Z¹ to the rest of the molecule of formula (II);
X⁰ stands for a blocking group different from Z¹ which is cleaved at a temperature above 100° C., or for a radical of formula (II′) 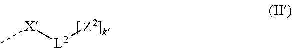
where Z² stands for a functional group which is different from Z¹ and from NCO and which is not reactive with isocyanate groups or is less reactive than the group HX′;
L² stands for a (k′+1)-valent organic radical which links the functional group Z² to the rest of the molecule of formula (II),
X′ stands for O, NH, NR³, or S,
where R³ stands for an alkyl radical that is branched or unbranched and/or saturated or unsaturated, or stands for an aryl or alkaryl radical that is optionally substituted, or stands for a radical of formula -L²-[Z²]_{k′}; and
k′ stands for 1 or 2 or 3;
k stands for 1 or 2 or 3;
v stands for 1 or 2 or 3, and
n stands for 2 or 3 or 4.

16. Composition containing the hybrid functional polymer as in claim 1.

17. (canceled)

18. Method for preparation of coatings, adhesives, or sealants, comprising mixing the hybrid-functional polymer as in claim 1 with at least one other component and carrying out a crosslinking reaction.

19. A method of obtaining a composite, comprising
adhesive bonding at least two substrates of the composition as in claim 16.

20. A hydroxy compound of formula (VI): 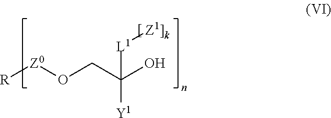
where:
R stands for an n-valent polymer radical;
Z⁰ stands for —CO— or —X—CO—R²—CO— or X—CO—[X¹]ₘA-; where:
X stands for O, NR⁴, or S, where R⁴ in turn stands for H or an alkyl group with 1 to 10 carbon atoms;
X¹ stands for NR⁴, CH₂, or C₂H₄;
m=0 or 1;
R² stands for a dicarboxylic acid radical after removal of the two carboxyl groups, in particular for a saturated or unsaturated, optionally substituted alkylene group with 1 to 6 carbon atoms or an optionally substituted phenylene group; and
A stands for an optionally substituted arylene radical;
Y¹ stands for H or for a methyl group;
Z¹ stands for a functional group which is different from NCO and which is not reactive with isocyanate groups;
L¹ stands for a (k+1)-valent organic radical which links the functional group Z¹ to the rest of the molecule of formula (I);
k stands for 1 or 2 or 3; and
n stands for 2 or 3 or 4.

21. A coating, adhesive, or sealant comprising the hybrid-functional polymer as in claim 1.
